(19) United States
(12) Patent Application Publication
(10) Pub. No.: US 2023/0345268 A1
(43) Pub. Date: Oct. 26, 2023

(54) COMMUNICATION METHOD AND APPARATUS

(71) Applicant: HUAWEI TECHNOLOGIES CO., LTD., Shenzhen (CN)

(72) Inventors: Jun WANG, Shanghai (CN); Yongxia LYU, Shenzhen (CN); Ting WANG, Shanghai (CN); Jianglei MA, Ottawa (CA); Liqing ZHANG, Ottawa (CA)

(21) Appl. No.: 18/342,185

(22) Filed: Jun. 27, 2023

Related U.S. Application Data
(63) Continuation of application No. PCT/CN2021/136889, filed on Dec. 9, 2021.

(30) Foreign Application Priority Data
Dec. 31, 2020 (CN) 202011633564.0

(51) Int. Cl. H04W 24/02

(52) U.S. Cl. CPC H04W 24/02; H04W 92/02

(57) ABSTRACT

The present disclosure relates to communication methods and apparatuses. In one example method, a first access network device determines configuration information, and sends the configuration information to a terminal. The first access network device is connected to a first core network device, and the first core network device uses a first or second communication standard. The configuration information includes status indication information of a first protocol layer (for example, a service data adaptation protocol (SDAP) layer) of the second communication standard, and the status indication information indicates the terminal to perform or not to perform a function of the first protocol layer. The first access network device determines a state of the first protocol layer based on a protocol layer specified in a communication standard of the core network device.

### CROSS-REFERENCE TO RELATED APPLICATIONS

This application is a continuation of International Application No. PCT/CN2021/136889, filed on Dec. 9, 2021, which claims priority to Chinese Patent Application No. 202011633564.0, filed on Dec. 31, 2020. The disclosures of the aforementioned applications are hereby incorporated by reference in their entireties.

### TECHNICAL FIELD

This application relates to the field of wireless communication technologies, and in particular, to a communication method and apparatus.

### BACKGROUND

In a 4th generation (4G) mobile communication standard, it is specified that a user plane protocol layer includes a packet data convergence protocol (PDCP) layer, a radio link control (RLC) layer, a medium access control (MAC) layer, and a physical (PHY) layer from top to bottom. A service data adaptation protocol (SDAP) layer is newly introduced in a 5th generation (5G) mobile communication standard compared with the 4G communication standard. The SDAP layer is above a PDCP layer, and is mainly used for performing, on an air interface, a function of mapping a quality of service flow (QoS flow) to a data radio bearer (DRB) between UE and a gNB. In a communication process, an access device configures related information of a DRB for a terminal based on a protocol layer. In this way, data can be transmitted between the terminal and the access device.

In a next-generation communication standard or a future communication standard, there are a plurality of possibilities for specifying a protocol layer. How to flexibly configure information about a protocol layer of a DRB for a terminal to allow for compatibility with a protocol layer that may be specified in a subsequent communication standard and a protocol layer that has been specified in an existing communication standard is a technical problem that needs to be resolved.

### SUMMARY

Embodiments of this application provide a communication method and apparatus, to resolve a problem of how to flexibly configure a protocol layer of a DRB for a terminal to allow for compatibility with a protocol layer that may be specified in a subsequent communication standard and a protocol layer that has been specified in an existing communication standard.

According to a first aspect, a communication method is provided. First, a first access network device determines first configuration information; and then the first access network device sends the first configuration information to a terminal. The first access network device is connected to a first core network device, and the first core network device uses a first communication standard or a second communication standard. The first configuration information includes status indication information of a first protocol layer of the second communication standard, the first protocol layer includes a service data adaptation protocol (SDAP) layer, the status indication information indicates a first state or a second state of the first protocol layer, the first state indicates the terminal to perform a function of the first protocol layer, and the second state indicates the terminal device not to perform a function of the first protocol layer.

In the first aspect, regardless of whether the first core network device accessed by the first access network device uses the first communication standard or the second communication standard, communication standards used by the first access network device for the first protocol layer configured for the terminal are unified as the second communication standard. In addition, there are two states for the first protocol layer (for example, the SDAP layer), to separately indicate whether to perform the function of the first protocol layer. The first access network device may determine, based on whether the protocol layer is specified in the communication standard (for example, a communication standard used by a core network device), whether the state of the first protocol layer is the first state or the second state. For example, if the SDAP layer is not specified in the communication standard, the state of the SDAP layer is configured as the second state. For example, if the SDAP layer is specified in the communication standard, the state of the SDAP layer is configured as the first state. Based on this state configuration manner, information about a protocol layer of a DRB can be flexibly configured for the terminal.

In a possible implementation, the first access network device sends a first message to a second access network device. The first message includes information that indicates a communication standard used by the first core network device. The first access network device explicitly indicates, to the second access network device, the communication standard used by the first core network connected to the first access network device, so that the second access network device learns of the communication standard used by the first core network connected to the first access network device. This may provide a reference for selecting a core network device of a specific communication standard in a terminal handover process.

In a possible implementation, the first access network device sends the first message to the second access network device through a first interface that uses the second communication standard. Communication standards used by interfaces connected between access network devices are unified, and are specifically unified as the second communication standard. A message is sent between the first access network device and the second access network device through an interface of the unified second communication standard.

In a possible implementation, the first access network device supports a second interface and a third interface. The first access network device is connected to the first core network device using the first communication standard through the second interface, where the second interface is defined in the first communication standard; or the first access network device is connected to the first core network device using the second communication standard through the third interface, where the third interface is defined in the second communication standard.

In a conventional technology, the access network device supports only an interface that is used for connecting the access network device to the core network device and that is defined in one communication standard, for example, supports only the second interface or the third interface. When the first access network device changes from a core network device connected to the first communication standard to a core network device connected to the second communication standard, the access network device needs to upgrade the second interface to the third interface. Alternatively, when the first access network device changes from a core network device connected to the second communication standard to a core network device connected to the first communication standard, the access network device needs to upgrade the third interface to the second interface. The upgrade process is complex. However, in this possible implementation, the first access network device supports interfaces that are used for connecting the access network device to the core network device and that are defined in a plurality of communication standards. After the communication standard used by the first core network device is updated, the first access network device may flexibly select an interface defined in a corresponding communication standard, to connect to the first core network device without upgrading the interface.

In a possible implementation, the first access network device receives a second message. The second message includes information that indicates a communication standard used by the first core network device.

In a possible implementation, the first access network device receives the second message from the first core network device; or the first access network device receives the second message from an operation and maintenance (OM) device.

The core network device or the operation and maintenance device configures, for the first access network device, a communication standard used by the core network device.

According to a second aspect, a communication method is provided. First, a terminal receives first configuration information from a first access network device. Then, the terminal may communicate with the first access network device based on the first configuration information. The first access network device is connected to a first core network device, and the first core network device uses a first communication standard or a second communication standard. The first configuration information includes status indication information of a first protocol layer of the second communication standard, the first protocol layer includes a service data adaptation protocol SDAP layer, the status indication information indicates a first state or a second state of the first protocol layer, the first state indicates the terminal to perform a function of the first protocol layer, and the second state indicates the terminal not to perform a function of the first protocol layer.

According to a third aspect, a communication method is provided. A second access network device receives a first message from a first access network device. The first message includes information that indicates a communication standard used by a first core network device, and the first core network device is connected to the first access network device.

In the third aspect, the first access network device explicitly indicates, to the second access network device, the communication standard used by the first core network connected to the first access network device, so that the second access network device learns of the communication standard used by the first core network connected to the first access network device. This may provide a reference for selecting a core network device of a specific communication standard in a terminal handover process.

According to a fourth aspect, a communication method is provided. A first core network device sends a second message to a first access network device. The second message includes information that indicates a communication standard used by the first core network device.

In the fourth aspect, the first core network device notifies the first access network device that the communication standard used by the first core network device may provide a reference for selecting a core network device of a specific communication standard in a terminal handover process. In addition, the second message explicitly indicates the communication standard used by the first core network, to reduce parsing difficulty of the first access network device.

According to a fifth aspect, a communication apparatus is provided. The apparatus has a function of implementing any one of the first aspect and the possible implementations of the first aspect, a function of implementing any one of the second aspect and the possible implementations of the second aspect, a function of implementing any one of the third aspect and the possible implementations of the third aspect, or a function of implementing any one of the fourth aspect and the possible implementations of the fourth aspect. The function may be implemented by hardware, or may be implemented by hardware by executing corresponding software. The hardware or software includes one or more functional modules corresponding to the foregoing function.

According to a sixth aspect, a communication apparatus is provided, including a processor. The processor is configured to execute a computer program or instructions, and when the computer program or the instructions is/are executed, the processor is configured to implement a function of the first access network device in the method according to any one of the first aspect and the possible implementations of the first aspect, or implement a function of the terminal in the method according to any one of the second aspect and the possible implementations of the second aspect, or implement a function of the second access network device in the method according to any one of the third aspect and the possible implementations of the third aspect, or implement a function of the core network device in the method according to any one of the fourth aspect or the possible implementations of the fourth aspect. The computer program or instructions may be stored in the processor, or may be stored in a memory, where the memory is coupled to the processor. The memory may be located in the communication apparatus, or may not be located in the communication apparatus.

In a possible implementation, the apparatus further includes a transceiver. The transceiver is configured to send a signal processed by the processor, or receive a signal input to the processor. The transceiver may perform a sending action or a receiving action performed by the first access network device in any one of the first aspect and the possible implementations of the first aspect, or perform a sending action or a receiving action performed by the terminal in any one of the second aspect and the possible implementations of the second aspect, or perform a sending action or a receiving action performed by the second access network device in any one of the third aspect and the possible implementations of the third aspect, or perform a sending action or a receiving action performed by the core network device in any one of the fourth aspect and the possible implementations of the fourth aspect.

According to a seventh aspect, this application provides a communication apparatus, including a processor and an interface circuit. The interface circuit is configured to: receive a signal from a communication apparatus other than the communication apparatus, and transmit the signal to the processor, or send a signal from the processor to a communication apparatus other than the communication apparatus. The processor is configured to implement, by using a logic circuit or executing code instructions, a function of the first access network device in the method according to any one of the first aspect and the possible implementations of the first aspect, or implement a function of the terminal in the method according to any one of the second aspect and the possible implementations of the second aspect, or implement a function of the second access network device in the method according to any one of the third aspect and the possible implementations of the third aspect, or implement a function of the core network device in the method according to any one of the fourth aspect or the possible implementations of the fourth aspect.

In a possible implementation, the communication apparatus is a chip system, and may include a chip, or may include a chip and another discrete component.

According to an eighth aspect, a computer-readable storage medium is provided, configured to store a computer program. The computer program includes instructions used to implement a function in any one of the first aspect and the possible implementations of the first aspect, or instructions used to implement a function in any one of the second aspect and the possible implementations of the second aspect, or instructions used to implement a function in any one of the third aspect and the possible implementations of the third aspect, or instructions used to implement a function in any one of the fourth aspect and the possible implementations of the fourth aspect.

Alternatively, a computer-readable storage medium is configured to store a computer program or instructions, and when the computer program or the instructions is/are executed by a communication apparatus, a function of the first access network device in the method according to any one of the first aspect and the possible implementations of the first aspect is implemented, or a function of the terminal in the method according to any one of the second aspect and the possible implementations of the second aspect is implemented, or a function of the second access network device in the method according to any one of the third aspect and the possible implementations of the third aspect is implemented, or a function of the core network device in the method according to any one of the fourth aspect or the possible implementations of the fourth aspect is implemented.

According to a ninth aspect, a computer program product is provided, and the computer program product includes computer program code. When the computer program code is run on a computer, the computer is enabled to perform the method performed by the first access network device in any one of the first aspect and the possible implementations of the first aspect, or perform the method performed by the terminal in any one of the second aspect and the possible implementations of the second aspect, or perform the method performed by the second access network device in any one of the third aspect and the possible implementations of the third aspect, or perform the method performed by the core network device in any one of the fourth aspect and the possible implementations of the fourth aspect.

According to a tenth aspect, a communication system is provided. The communication system includes a first access network device that performs the method in any one of the first aspect and the possible implementations of the first aspect, and a terminal that performs the method in any one of the second aspect and the possible implementations of the second aspect. Alternatively, the communication system includes a first access network device that performs the method in any one of the first aspect or the possible implementations of the first aspect, and a second access network device that performs the method in any one of the third aspect or the possible implementations of the third aspect. Alternatively, the communication system includes a first access network device that performs the method in any one of the first aspect and the possible implementations of the first aspect, and a core network device that performs the method in any one of the fourth aspect and the possible implementations of the fourth aspect.

For technical effects of the fifth aspect to the tenth aspect, refer to the descriptions in the first aspect to the fourth aspect. Details are not repeatedly described again.

### BRIEF DESCRIPTION OF DRAWINGS

FIG. 1 is a schematic diagram of an architecture of a dual connectivity communication system according to an embodiment of this application;

FIG. 2 is a schematic diagram of an existing MR-DC with EPC protocol stack according to an embodiment of this application;

FIG. 3 is a schematic diagram of an existing MR-DC with 5GC protocol stack according to an embodiment of this application;

FIG. 4 is a schematic diagram of a master node-secondary node dual connectivity protocol stack according to an embodiment of this application;

FIG. 5 is a schematic diagram of a terminal protocol stack according to an embodiment of this application;

FIG. 6 is a schematic diagram of a communication process according to an embodiment of this application;

FIG. 7 is a schematic diagram of a function of dual connectivity according to an embodiment of this application;

FIG. 8a is a schematic diagram of a dual connectivity protocol stack according to an embodiment of this application;

FIG. 8b is a schematic diagram of a dual connectivity protocol stack according to an embodiment of this application;

FIG. 8c is a schematic diagram of a dual connectivity protocol stack according to an embodiment of this application;

FIG. 9 is a diagram of a structure of a communication apparatus according to an embodiment of this application; and

FIG. 10 is a diagram of a structure of a communication apparatus according to an embodiment of this application.

### DESCRIPTION OF EMBODIMENTS

The following describes in detail embodiments of this application with reference to accompanying drawings.

To facilitate understanding of technical solutions in embodiments of this application, the following briefly describes a system architecture of a method provided in embodiments of this application. It may be understood that the system architecture described in embodiments of this application is intended to describe the technical solutions in embodiments of this application more clearly, and do not constitute any limitation on the technical solutions provided in embodiments of this application.

The technical solutions in embodiments of this application may be applied to various communication systems, for example, a satellite communication system, a conventional mobile communication system, and a non-terrestrial network (NTN) communication system. The communication system is, for example, a wireless local area network communication system, a long-term evolution (LTE) system, an LTE frequency division duplex (FDD) system, an LTE time division duplex (TDD) system, a 5G or new radio (NR) mobile communication system, a 6th generation (6G) mobile communication system, and a future mobile communication system.

For ease of understanding embodiments of this application, the following describes an application scenario of this application. A network architecture and a service scenario described in embodiments of this application are intended to describe the technical solutions in embodiments of this application more clearly, and do not constitute any limitation on the technical solutions provided in embodiments of this application. A person of ordinary skill in the art may learn that, as a new service scenario emerges, the technical solutions provided in embodiments of this application are also applicable to a similar technical problem.

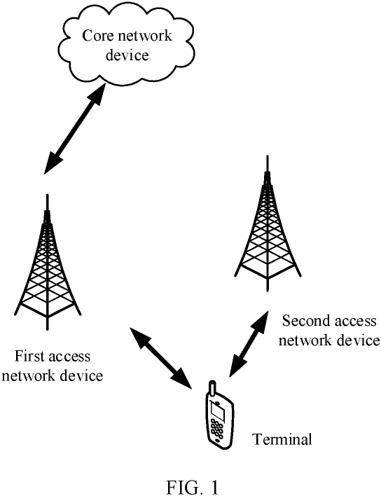

FIG. 1 is an architecture of a dual connectivity (DC) communication system to which a communication method according to an embodiment of this application is applicable. A terminal may access two access network devices: a first access network device and a second access network device, and connection between the first access network device and the second access network device exists. The two access network devices may use different or same communication standards. Optionally, the first access network device may be connected to a core network device. Optionally, the second access network device may be connected to a core network device. The access network device and the core network device may use a 4G communication standard, a 5G communication standard, a 6G communication standard, or the like.

For ease of understanding of embodiments of this application, the following describes some terms and related technologies in embodiments of this application, to help a person skilled in the art have a better understanding.

(1) An access network device may be a base station, an evolved NodeB (eNodeB), a transmission reception point (TRP), a next generation NodeB (gNB) in a 5th generation (5G) mobile communication system, a next generation NodeB in a 6th generation (6G) mobile communication system, a base station in a future mobile communication system, an access node in a Wi-Fi system, or the like; or the access network device may be a module or a unit that implements some of functions of a base station, for example, may be a central unit (CU), or may be a distributed unit (DU). The access network device may be a macro base station, a micro base station or an indoor base station, or a relay node or a donor node. A specific technology and a specific device form that are used for the access network device are not limited in this embodiment of this application.

In this embodiment of this application, a function of the access network device may alternatively be performed by a module (for example, a chip) in the access network device, or may be performed by a control subsystem including the function of the access network device. The control subsystem that includes the function of the access network device herein may be a control center in the foregoing terminal application scenarios such as a smart grid, industrial control, smart transportation, and a smart city.

(2) A terminal may also be referred to as a terminal device, user equipment (UE), a mobile station, a mobile terminal, or the like. The terminal may be widely applied to various scenarios, for example, device-to-device (D2D), vehicle to everything (V2X) communication, machine-type communication (MTC), internet of things (IOT), virtual reality, augmented reality, industrial control, self-driving, telemedicine, a smart grid, smart furniture, a smart office, smart wearable, smart transportation, and a smart city. The terminal may be a mobile phone, a tablet computer, a computer with a wireless transceiver function, a wearable device, a vehicle, an uncrewed aerial vehicle, a helicopter, an airplane, a ship, a robot, a robotic arm, a smart home device, or the like. A specific technology and a specific device form used by the terminal are not limited in this embodiment of this application.

A function of the terminal may alternatively be performed by a module (such as a chip or a modem) in the terminal, or may be performed by an apparatus including the function of the terminal.

The access network device and the terminal may be at fixed locations, or may be movable. The access network device and the terminal may be deployed on land, including indoor, outdoor, handheld, or vehicle-mounted; may be deployed on a water surface; or may be deployed on an airplane, a balloon, or an artificial satellite in the air. An application scenario of the access network device and the terminal is not limited in embodiments of this application.

(3) A core network device, for example, an access management network element, is a control plane network element provided by an operator network, and is responsible for access control and mobility management when a terminal device accesses the operator network, for example, including functions such as mobility status management, allocation of a temporary user identity, and user authentication. In a 4G communication system, the access management network element may be a mobility management entity (MME). In a 5G communication system, the access management network element may be an access and mobility management function (AMF) network element. In a future communication system, the access management network element may still be the AMF network element, or may have another name. This is not limited in this application.

The core network device, for example, a user plane network element, is responsible for forwarding and receiving user data in the terminal device. The user plane network element may receive the user data from the data network, and transmit the user data to the terminal device through the access network device. In addition, the user plane network element may alternatively receive the user data from the terminal device through the access network device, and forward the user data to the data network. A transmission resource and a scheduling function that are in the user plane network element and that provide a service for the terminal device are managed and controlled by a session management function (SMF) network element. In the 4G communication system, the user plane network element may be a serving gateway (SGW). In the 5G communication system, the user plane network element may be a user plane function (UPF) network element. In a future communication system, the user plane network element may still be the UPF network element, or may have another name. This is not limited in this application.

(4) The following describes a dual connectivity communication system in detail. For ease of description, a part of content in the following uses an example in which a base station is used as an access network device for description.

In a first release of NR, that is, release 15 (R15), there are two options for splitting between an LTE system and an NR system based on operator deployment requirements (NR base stations are not deployed on a large scale at the beginning and are deployed locally as only some of hotspots, and therefore UE is served in non-standalone networking mode to improve uplink and downlink transmission rates of the UE).

Option 1: Cross-radio access technology (RAT) carrier aggregation (CA), that is, an X-RAT CA mode. This mode requires an ideal backhaul line (backhaul) (that is, a transmission delay of ms or even µs level, and only optical fibers can meet this requirement) between an LTE base station and an NR base station. However, optical fiber deployment in most countries or regions is extremely rare. Therefore, an actual deployment probability of X-RAT CA is low.

Option 2: X-RAT dual connectivity DC mode. This mode requires no ideal backhaul between an LTE base station and an NR base station. Therefore, this mode is finally used. In addition, a related X-RAT DC solution is standardized in NR R15.

In NR R15, a plurality of networking options of multi-radio dual connectivity (MR-DC) are proposed, which are specifically as follows:

opt2/2a/2x may also be referred to as an NR DC networking mode. A terminal is connected to two 5G NR base stations at the same time. Both a master node (MN) and a secondary node (SN) are NR base stations (gNB), and the master node and/or the secondary node are/is connected to a 5G core network device (for example, connected to an AMF device and/or a UPF device). The node may be considered as an access network device.

opt3/3a/3x may also be referred to as an EN-DC (E-UTRA and NR DC) networking mode. A terminal is connected to both a 4G LTE base station and a 5G NR base station. A master node is an eLTE base station (e-eNB), a secondary node is an NR base station (gNB), and the master node and/or the secondary node are/is connected to a 4G CN (for example, connected to an MME device and/or an SGW device).

opt4/4a/4x may also be referred to as an NE-DC (NR, E-UTRA-DC) networking mode. A terminal is connected to both a 4G LTE base station and a 5G NR base station. A master node is an NR base station (gNB), a secondary node is an eLTE base station (e-eNB), and the master node and/or the secondary node are/is connected to a 5G core network device (for example, connected to an AMF device and/or a UPF device).

opt7/7a/7x may also be referred to as an NGEN-DC (next generation (NG) E-UTRA and NR DC) networking mode. A terminal is connected to both a 4G LTE base station and a 5G NR base station. A master node is an eLTE base station (e-eNB), a secondary node is an NR base station (gNB), and the master node and the secondary node are connected to a 5G core network device (for example, connected to an AMF device and/or a UPF device).

The following uses opt2/2a/2x as an example.

opt2 means that a user plane device (or a user plane network element) of a core network is connected only to a master node (MN), and is not connected to a secondary node SN, and the master node (MN) splits UE data to the secondary node SN.

opt2a means that a user plane device of a core network (CN) is connected to both a master node (MN) and a secondary node (SN), there is no data splitting path between the master node MN and the secondary node (SN), and the CN network element makes a data splitting decision.

opt2x means that a user plane device of a core network is connected only to a secondary node SN, and is not connected to a master node (MN). There is a data splitting path between the secondary node SN and the master node (MN), and the secondary node (SN) splits UE data to the master node MN.

In any architecture of opt2/2a/2x, a control plane device (or a control plane network element) of a core network is connected to only a master node (MN), and is not connected to a secondary node SN.

opt3/3a/3x, opt4/4a/4x, and opt7/7a/7x are similar to opt2/2a/2x. Details are not repeatedly described again.

To support the foregoing four networking architectures (opt2/2a/2x, opt3/3a/3x, opt4/4a/4x, and opt7/7a/7x), NR R15 provides two different protocol stacks and corresponding solutions.

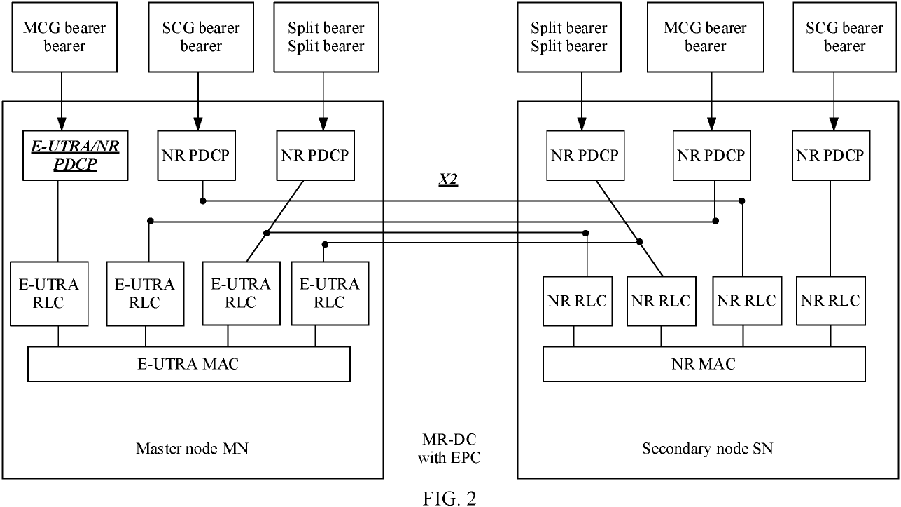

A protocol stack shown in FIG. 2 is referred to as an MR-DC with evolved packet core (EPC) network, and corresponds to the foregoing EN-DC networking architecture (that is, opt3/3a/3x). A master node is connected to a control plane device of a 4G core network.

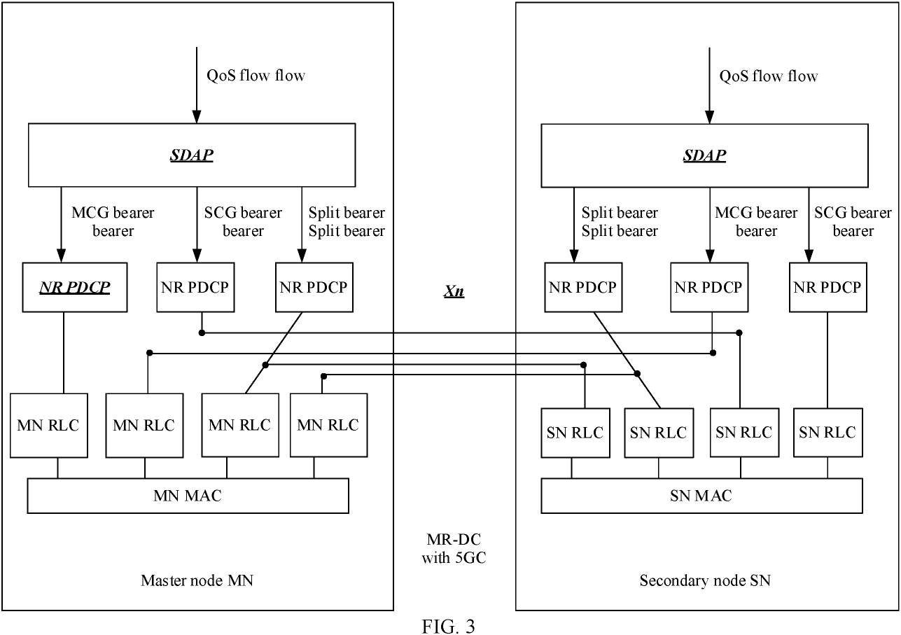

A protocol stack shown in FIG. 3 is referred to as an MR-DC with a 5th generation core (5GC) network, and corresponds to a sum of the foregoing three networking architectures: NE-DC, NGEN-DC, and NR-DC. A master node is connected to a control plane device of a 5G core network.

With reference to the foregoing two protocol stacks, protocol layers included in a 4G communication standard and a 5G communication standard are described.

In the 4G communication standard, a user plane protocol layer includes a PDCP layer, an RLC layer, a MAC layer, and a PHY layer from top to bottom. A control plane protocol layer includes a radio resource control (RRC) layer, a PDCP layer, an RLC layer, a MAC layer, and a PHY layer from top to bottom. For functions of each layer, refer to functions described in the 4G communication standard. Details are not described again.

In the 5G communication standard, a user plane protocol layer includes an SDAP layer, a PDCP layer, an RLC layer, a MAC layer, and a PHY layer from top to bottom. A control plane protocol layer includes an RRC layer, a PDCP layer, an RLC layer, a MAC layer, and a PHY layer from top to bottom. For functions of each layer, refer to functions described in the 5G communication standard. Details are not described again.

Differences between the two protocol stacks are as follows:

Difference 1 lies in the SDAP layer. The SDAP layer is a layer newly introduced in 5G compared with 4G, and exists only for a user plane. The SDAP layer is mainly used for performing, on an air interface, a function of mapping a QoS flow to a DRB between UE and a gNB. In the protocol stack MR-DC with EPC shown in FIG. 2, the master node and a secondary node are connected to a 4G core network device, and protocol stacks of the master node, the secondary node, and the UE do not include the SDAP layer. In the protocol stack MR-DC with 5GC shown in FIG. 3, the master node and the secondary node are connected to a 5G core network device, and protocol stacks of the master node, the secondary node, and the UE include the SDAP layer.

Difference 2 lies in the PDCP layer. In the protocol stack MR-DC with EPC shown in FIG. 2, for an MN terminated master cell group (MCG) bearer (MN terminated MCG bearer) (that is, the MN is connected to the CN, and data of the terminal on the bearer is transmitted on the MN instead of the SN), both E-UTRA PDCP and NR PDCP modules (or entities) are supported. However, in the protocol stack MR-DC with 5GC shown in FIG. 3, for the MN terminated MCG bearer, only the NR PDCP module is supported.

Difference 3 lies in that interfaces for communication between the master node and the secondary node are an X2 interface and an Xn interface. In the protocol stack MR-DC with EPC shown in FIG. 2, an X2 interface or protocol defined in the 4G (LTE) communication standard is used between the master node (MN) and the secondary node SN to bear/transmit a communication message/signaling between nodes. However, in the protocol stack MR-DC with 5GC shown in FIG. 3, an Xn interface or protocol defined in the 5G (NR) communication standard is used between the master node (MN) and the secondary node (SN) to bear/transmit a communication message/signaling between nodes.

A secondary cell group (slave cell group (SCG)) bearer and a split bearer in the two protocol stacks are not described in detail.

Some terms and related technologies in the embodiments of this application have been described above, and the following describes the technical solutions of this application in detail with reference to the accompanying drawings. Features or content denoted by dashed lines in the accompanying drawings may be understood as optional operations or optional structures in embodiments of this application.

This application provides a new dual connectivity protocol stack, which is divided into three parts. First, communication standards used by protocol layers included in a dual connectivity protocol stack are unified. Second, communication standards used by an interface (for example, defined as a radio access network (RAN)-RAN interface) that is included in the dual connectivity protocol stack and that is used for two-node connection are unified. Third, the dual connectivity protocol stack is compatible with an interface (for example, defined as a CN-RAN interface) that is used for connecting the master node and the core network device and that is defined in a plurality of communication standards. Fourth, the new dual connectivity protocol stack is equivalent to deleting some of functions from the MR-DC protocol stacks in FIG. 2 and FIG. 3, to reduce system complexity. The following describes the four parts in four embodiments. The four embodiments may be used as a separate embodiment, or two or three or four embodiments may be combined to form a new embodiment.

Embodiment 1: Communication standards used by protocol layers included in the dual connectivity protocol stack are unified.

Compared with a 5G communication standard, in a subsequent communication standard (for example, a 6G communication standard or a 7^{th} generation (7G) communication standard), specified protocol layers may be the same, or one or more protocol layers may be deleted or one or more new protocol layers may be added based on a protocol layer specified in a communication standard such as 5G. For example, a PDCP layer or an SDAP layer is deleted. For example, one or more new protocol layers are added above the SDAP layer. For example, one or more new protocol layers are added above the PDCP layer. For example, one or more new protocol layers are added below the PDCP layer. In this application, the newly added protocol layer is defined as an xDAP layer. A function implemented by the xDAP layer may be at least one of the following functions: partial core network function, partial SDAP layer function, and partial RLC layer function. A function of the xDAP layer is not specifically limited in this application. The new dual connectivity protocol stack provided in this application includes some or all of an xDAP layer, an SDAP layer, a PDCP layer, an RLC layer, a MAC layer, and a PHY layer. In a scenario in which the master node is connected to core network devices of different communication standards, communication standards used by protocol layers in the dual connectivity protocol stack are unified.

The xDAP layer is used as an example. The xDAP layer in the protocol stack of the master node and the protocol stack of the secondary node is an xDAP layer in a 6G communication standard, an xDAP layer in a 7G communication standard, or an xDAP layer in a communication standard of a latest release.

The SDAP layer is used as an example. The SDAP layer in the protocol stack of the master node and the protocol stack of the secondary node is an SDAP layer in a 5G communication standard, an SDAP layer in a 6G communication standard, an SDAP layer in a 7G communication standard, or an SDAP layer in a communication standard of a latest release.

The PDCP layer is used as an example. The PDCP layer in the protocol stack of the master node and the protocol stack of the secondary node is a PDCP layer in a 4G communication standard, an SDAP layer in a 5G communication standard, a PDCP layer in a 6G communication standard, a PDCP layer in a 7G communication standard, or a PDCP layer in a communication standard of a latest release. For example, refer to FIG. 2 and FIG. 3. When the master node is connected to core network devices of different communication standards, for an MN terminated MCG bearer, different communication standards are used at the PDCP layer. However, in the new dual connectivity protocol stack provided in this application, for the MN terminated MCG bearer, a same communication standard is used at the PDCP layer, for example, a PDCP layer in a communication standard of a latest release.

The RLC layer, the MAC layer, and the PHY layer are used as an example. In the protocol stack of the master node, the RLC layer, the MAC layer, and the PHY layer are respectively an RLC layer of a communication standard used by the master node, a MAC layer of a communication standard used by the master node, and a PHY layer of a communication standard used by the master node. In the protocol stack of the secondary node, the RLC layer, the MAC layer, and the PHY layer are respectively an RLC layer of a communication standard used by the secondary node, a MAC layer of a communication standard used by the secondary node, and a PHY layer of a communication standard used by the secondary node. For example, the communication standard used by the master node is a 5G communication standard, a 6G communication standard, a 7G communication standard, or a subsequent communication standard. The communication standard used by the secondary node is a 5G communication standard, a 6G communication standard, a 7G communication standard, or a subsequent communication standard.

The 4G communication standard may alternatively be replaced with evolved universal terrestrial radio access (E-UTRA), the 5G communication standard may alternatively be replaced with NR, 6G may alternatively be replaced with any name that can represent 6G, and 7G may alternatively be replaced with any name that can represent 7G.

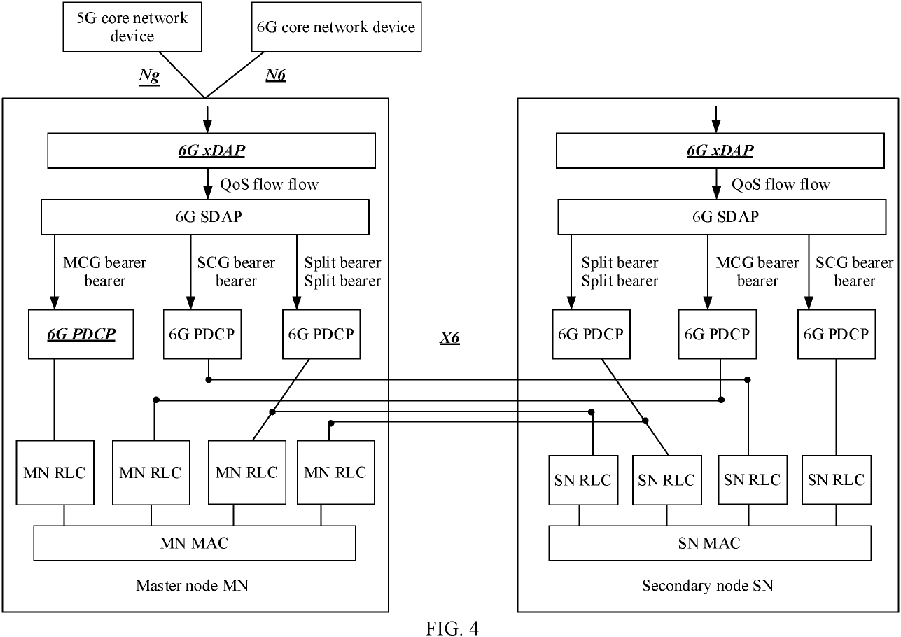

As shown in FIG. 4, this application provides a schematic diagram of a dual connectivity protocol stack (for a part that is repeated with FIG. 2 and FIG. 3, refer to an existing standard specification, and details are not repeatedly described again). It is regardless of whether the master node is connected to the 5G core network device or connected to the 6G core network device. In the protocol stack of the master node and the protocol stack of the secondary node, the xDAP layer, the SDAP layer, and the PDCP layer are respectively an xDAP layer of the 6G communication standard, an SDAP layer of the 6G communication standard, and a PDCP layer of the 6G communication standard. In the protocol stack of the master node, the RLC layer and the MAC layer are respectively an RLC layer (that is, MN RLC) of a communication standard used by the master node and a MAC layer (that is, MN MAC) of a communication standard used by the master node. In the protocol stack of the secondary node, the RLC layer and the MAC layer are respectively an RLC layer (that is, SN RLC) of a communication standard used by the secondary node and a MAC layer (that is, SN MAC) of a communication standard used by the secondary node.

As described above, in a subsequent communication standard, when a protocol layer is specified, one or more protocol layers may be deleted, or one or more protocol layers may be added. To flexibly configure related information of a DRB for the terminal to allow for compatibility with a protocol layer that may be specified in a subsequent communication standard and a protocol layer that has been specified in an existing communication standard, optionally, the new dual connectivity protocol stack provided in this application may further include a status corresponding to the protocol layer. The status has two states: a first state and a second state. The first state indicates that a function of the protocol layer is not performed, or a function of the protocol layer is disabled, or the protocol layer only transparently transmits a data packet, and the data packet does not include a packet header of the protocol layer. The second state indicates that a function of the protocol layer is performed, a function of the protocol layer is enabled, or a data packet includes a packet header of the protocol layer. The “state” is only a definition of a function, and any name that expresses the function is applicable. For example, the “state” is replaced with a “mode”. The first mode may also be referred to as a transparent mode, and the second mode may also be referred to as a non-transparent mode. The first state may also be referred to as an enabled state, and the second state may also be referred to as a disabled state.

For example, in the new dual connectivity protocol stack provided in this application, a status is separately set for one or more layers of the xDAP layer, the SDAP layer, and the PDCP layer.

Whether the protocol layer in the master node or the secondary node is in the first state or the second state depends on a communication standard used by the core network device connected to the master node. The communication standard used by the core network device connected to the master node is determined based on a dual connectivity architecture in which the master node is located. The following uses an example in which an xDAP layer is newly added to the 6G communication standard to describe the status.

For example, for an EN-DC-like 5G/6G DC architecture, the MN is an NR base station, the SN is a 6G base station, and the CN is a 5G CN. Neither the protocol stack of the MN nor the protocol stack of SN has the xDAP layer; or both protocol stacks of the MN and the SN have the xDAP layer, but the status of the xDAP layer is the first state (or the transparent mode), and all functions of the xDAP layer are disabled.

For another example, for an NGEN-DC-like 5G/6G DC architecture, the MN is an NR base station, the SN is a 6G base station, and the CN is a 6G CN. Because the 6G CN is connected, the xDAP layer needs to be introduced or enabled for both the MN and the SN. The status of the xDAP layer is the second state (the non-transparent mode), and all functions of the xDAP layer are enabled.

For another example, for an NE-DC-like 5G/6G DC architecture, the MN is a 6G base station, the SN is an NR base station, and the CN is a 6G CN. The status of the xDAP layer is the second state (the non-transparent mode).

For another example, for an NR-DC-like 6G/6G DC architecture (the MN is a 6G base station, the SN is a 6G base station, and the CN is a 6G CN), the status of the xDAP layer is the second state (the non-transparent mode).

The following describes a terminal protocol stack with reference to the dual connectivity protocol stack described above.

For example, a protocol layer included in the terminal protocol stack is the same as the protocol layer included in the foregoing described dual connectivity protocol stack, and a communication standard used by each protocol layer in the terminal protocol stack is also the same as the communication standard used by the protocol layer in the foregoing described dual connectivity protocol stack.

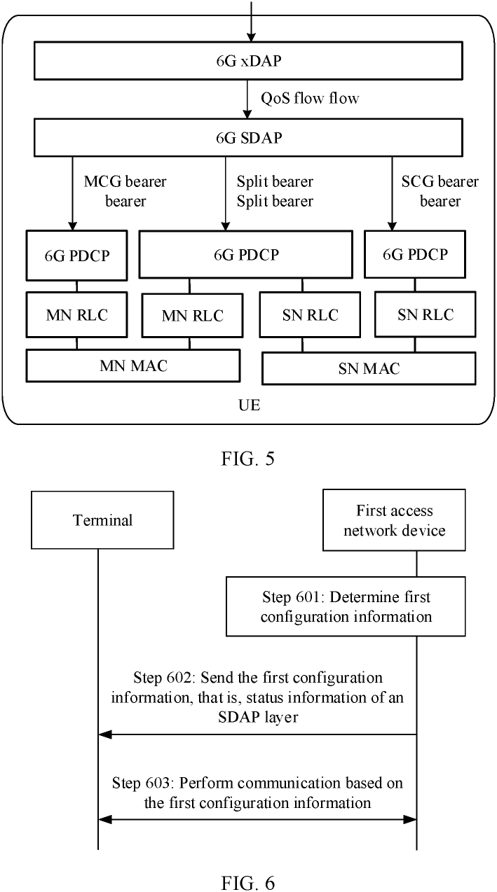

As shown in FIG. 5, a terminal protocol stack corresponding to the dual connectivity protocol stack shown in FIG. 4 is provided. The xDAP layer, the SDAP layer, and the PDCP layer are respectively an xDAP layer of the 6G communication standard, an SDAP layer of the 6G communication standard, and a PDCP layer of the 6G communication standard. The RLC layer and the MAC layer are respectively an RLC layer (that is, MN RLC) of a communication standard used by the master node and a MAC layer (that is, MN MAC) of a communication standard used by the master node; and are respectively an RLC layer (that is, SN RLC) of a communication standard used by the secondary node and a MAC layer (that is, SN MAC) of a communication standard used by the secondary node.

Optionally, the terminal protocol stack may include some or all of the xDAP layer, the SDAP layer, the PDCP layer, the RLC layer, the MAC layer, and the PHY layer. For example, the xDAP layer and/or the SDAP layer are/is not included.

The following describes, with reference to the dual connectivity protocol stack described above, an example in which a first access network device configures related information of a protocol layer of a data radio bearer DRB for a terminal. The first access network device may be a master node.

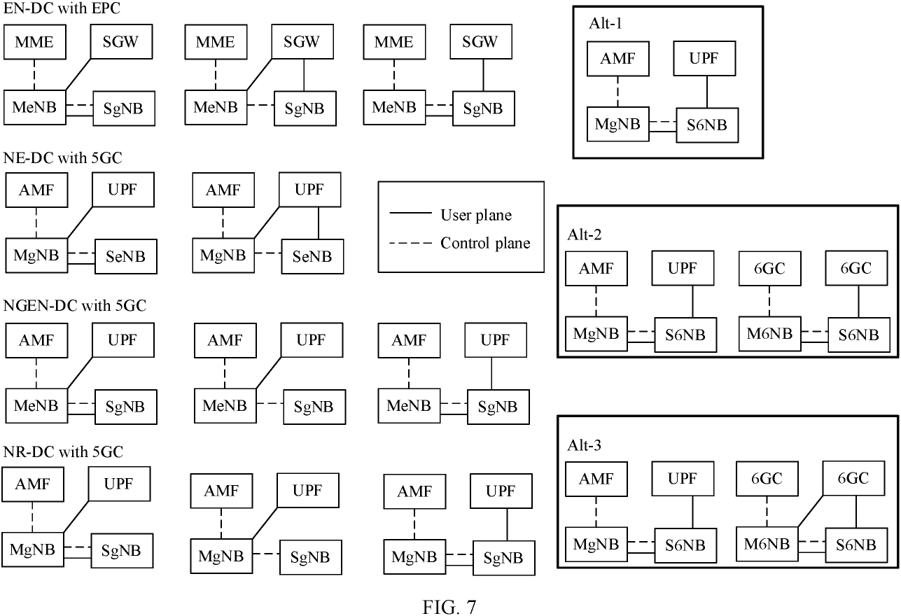

As shown in FIG. 6, a schematic diagram of a communication process is provided, which specifically includes the following steps.

It should be noted that the first access network device is connected to a first core network device, and the first core network device uses a first communication standard or a second communication standard.

Step 601: The first access network device determines first configuration information.

Step 602: The first access network device sends the first configuration information to the terminal. Correspondingly, the terminal receives the first configuration information from the first access network device.

Step 603: The terminal communicates with the first access network device based on the first configuration information.

In an example, the first configuration information includes status indication information of a first protocol layer of the second communication standard, and the first protocol layer includes a service data adaptation protocol SDAP layer. The status indication information indicates a first state or a second state of the first protocol layer, the first state indicates the terminal to perform a function of the first protocol layer, and the second state indicates the terminal device not to perform a function of the first protocol layer. As described above, the “state” can be replaced with the “mode”. Details are not repeatedly described herein again.

Regardless of whether the first core network device accessed by the first access network device uses the first communication standard or the second communication standard, communication standards used by the first access network device for the first protocol layer configured for the terminal are unified as the second communication standard. In this way, for the terminal, regardless of a scenario in which the terminal is located, for example, an EN-DC scenario, an NE-DC scenario, an NGEN-DC scenario, or an NR-DC scenario, the terminal needs only to support a first protocol layer function of the unified second communication standard, and does not need to support a plurality of protocol stack functions. In addition, because two sets of protocol stacks in the conventional technology are unified, a protocol stack upgrade scenario is not involved subsequently.

In addition, there are two states for the first protocol layer (for example, the SDAP layer), to separately indicate whether to perform a function of the first protocol layer. The first access network device may determine, based on whether the protocol layer is specified in the communication standard (for example, a communication standard used by a core network device), whether the state of the first protocol layer is the first state or the second state. For example, if the SDAP layer is not specified in the communication standard, the state of the SDAP layer is configured as the second state. For example, if the SDAP layer is specified in the communication standard, the state of the SDAP layer is configured as the first state. Based on this state configuration manner, related information of the protocol layer of the DRB can be flexibly configured for the terminal.

The second communication standard may be a 4G communication standard, a 5G communication standard, a 6G communication standard, a 7G communication standard, or any subsequent communication standard. In an example, the second communication standard is a latest communication standard in existing communication standards, or the second communication standard is a communication standard of a new release compared with the first communication standard.

Optionally, the first configuration information further includes other related information of the first protocol layer of the second communication standard. For example, information about a protocol layer in the conventional technology is included.

Optionally, the first protocol layer further includes but is not limited to at least one of the PDCP layer and the xDAP layer. To be specific, the first access network device may configure, for the terminal, related information of the PDCP layer in the second communication standard, related information of the xDAP layer in the second communication standard, and the like.

Optionally, the first configuration information does not include related information of the first protocol layer in the first communication standard.

Optionally, the first configuration information may further include but is not limited to: one or more of related information of an RLC layer in a third communication standard, related information of a MAC layer in the third communication standard, or related information of a PHY layer in the third communication standard. The third communication standard is a communication standard used by the first access network device. For example, the communication standard used by the first access network device is a 5G communication standard, a 6G communication standard, a 7G communication standard, or any subsequent communication standard.

Content in the first configuration information may be generated by the master node, or may be generated by the secondary node and then sent to the master node, and then configured by the master node for the terminal.

It may be understood that, on a basis that the dual connectivity protocol stack has specified, the first access network device may always perform configuration based on the first configuration information described above when configuring the related information of the protocol layer of the DRB for the terminal.

In addition, an RRC protocol of the 3^{rd} generation partnership project (3GPP), for example, the technical specifications (TS) 36.331 and TS 38.331, describes MR-DC related procedures, and separately describes procedures for architectures such as EN-DC, NGEN-DC, NR-DC and NE-DC. Behaviors of these procedures are basically the same, and only slight differences exist. This application proposes a unified dual connectivity protocol stack. Therefore, for MN RRC and SN RRC, a description amount may also be reduced in a subsequent communication standard.

Embodiment 2: Communication standards used by an interface (for example, defined as a RAN-RAN interface) that is included in the dual connectivity protocol stack and that is used for two-node connection are unified.

With reference to FIG. 2 and FIG. 3, when the master node is connected to the 4G core network device, the master node and the secondary node are connected through an X2 interface defined in the 4G communication standard; and when the master node is connected to the 5G core network device, the master node and the secondary node are connected through an Xn interface defined in the 5G communication standard.

When the 4G core network device is upgraded to the 5G core network device, a networking architecture on a base station side also needs to be upgraded, for example, an EN-DC architecture is upgraded to an NGEN-DC architecture. As described above, in the EN-DC architecture, the master node is an e-eNB, and the master node is connected to the 4G core network device; and in the NGEN-DC architecture, the master node is an e-eNB, and the master node is connected to the 5G core network device. Compared with the master node e-eNB in the EN-DC architecture, the master node e-eNB in the NGEN-DC architecture has been upgraded. When the EN-DC architecture needs to be upgraded to the NGEN-DC architecture due to upgrade of the core network device, the master node e-eNB needs to be upgraded again or re-upgraded, to support conversion from the X2 interface to the Xn interface.

According to the new dual connectivity protocol stack provided in this application, interfaces (for example, defined as RAN-RAN interfaces) for connecting two access network devices are unified. An interface connected between two access network devices is referred to as a first interface in the following.

When the master node is connected to a core network device of the first communication standard, the second communication standard, or another communication standard, a same communication standard is used for the first interface between the master node and the secondary node. For example, when the master node is connected to the core network device of the first communication standard, the first interface between the master node and the secondary node is an interface defined in the second communication standard. When the master node is connected to the core network device of the second communication standard, the first interface between the master node and the secondary node is an interface defined in the second communication standard. When the master node is connected to the core network device of the third communication standard, the first interface between the master node and the secondary node is an interface defined in the second communication standard.

The second communication standard may be a 4G communication standard, a 5G communication standard, a 6G communication standard, a 7G communication standard, or any subsequent communication standard. In an example, the second communication standard is a latest communication standard in existing communication standards, or the second communication standard is a communication standard of a new release compared with the first communication standard and the third communication standard.

For example, as shown in FIG. 4, regardless of whether the master node is connected to the 5G core network device or the 6G core network device, the master node and the secondary node are connected through a first interface (for example, an X6 interface) defined in the 6G communication standard. In this way, when the core network is upgraded, complexity caused by upgrade of the first interface can be avoided.

In addition, in a terminal handover scenario, target cells need to be distinguished. For example, the terminal is allowed to be handed over only to a 6G base station connected to a 6G core network device, and is not allowed to be handed over to a 6G base station connected to a 5G core network device. Therefore, the terminal needs to learn a communication standard used by the core network device. The access device may notify the terminal of a communication standard used by a currently connected core network device. In this way, the terminal can select a proper communication system for handover. In a dual connectivity scenario, two nodes may exchange a communication standard used by a core network device connected to the two nodes (it should be noted that when the communication standard used by the core network device is exchanged, the two nodes are not divided into the master and secondary nodes).

Currently, when the first node in the dual connectivity scenario sends a message to the second node through the X2 interface or the Xn interface, the second node may determine, based on a format of the message, whether a communication standard used by a core network connected to the first node is a 4G communication standard or a 5G communication standard. However, after the communication standards used by the first interface are unified, the communication standard used by the core network device cannot be determined based on a format of the message. Based on this, this application further provides an example: The first node may explicitly indicate, to the second node, a communication standard used by the core network device. For example, a first access network device sends a first message to a second access network device. The first message includes information that indicates a communication standard used by the first core network device, and the first core network device is connected to the first access network device. Correspondingly, the second access network device receives the first message sent by the first access network device. Optionally, the first access network device is a master node, and the second access network device is a secondary node.

In an example, that a first access network device sends a first message to a second access network device specifically includes: The first access network device sends the first message to the second access network device through a first interface that uses the second communication standard. Correspondingly, that the second access network device receives the first message sent by the first access network device specifically includes: The second access network device receives the first message sent by the first access network device through the first interface that uses the second communication standard. In addition to the first message, the first interface that uses the second communication standard may also transmit a message transmitted in existing DC. For example, the message may be a message in negotiation between the master node (MN) and the secondary node (SN). For example, some of functions or features (for example, UE uplink power is constant) need to be shared between the MN and the SN due to capability constraints of the UE. For example, if uplink of the UE is sent to the master node (MN) and the secondary node SN concurrently, a power ratio for the MN and the SN needs to be determined (for example, 7:3, where power of the MN accounts for 70% of total transmit power, and power of the SN accounts for 30% of total transmit power). Similarly, more parameters need to be negotiated. For example, the MN and the SN cannot simultaneously configure measurement of the same frequency for the UE or reporting of a cell global identity (CGI), or a total quantity of measurement objects simultaneously configured by the MN and the SN for the UE is limited. In addition, the MN may obtain configurations delivered by the SN to the UE. It may be understood that these configurations are negotiated based on this mechanism. This is also the same for the SN. The message transmitted in existing DC may alternatively be an existing X2 or Xn message. For example, to support procedures such as SN addition/modification/deletion, MN change, and handover from a DC architecture to a non-DC architecture, messages need to be transmitted between stations by using X2/Xn signaling. These messages may be triggered by the MN, or may be triggered by the SN.

The message transmitted in existing DC may be, for example, a message used by the master node and the secondary node to notify a capability supported by the master node and the secondary node, for example, a message in a procedure of handover from the DC architecture to the non-DC architecture.

The following describes an example in which the first access network device learns of the communication standard used by the first core network device.

For example, the first access network device receives a second message. The second message includes information that indicates the communication standard used by the first core network device. The first access network device learns of the communication standard used by the first core network device connected to the first access network device, and may provide a reference for selecting a core network device of a specific communication standard in a terminal handover process. In addition, in this possible implementation, the second message explicitly indicates the communication standard used by the first core network, to reduce parsing difficulty of the first access network device.

In an example, the first access network device receives the second message from the first core network device. Correspondingly, the first core network device sends the second message to the first access network device.

In an example, the first access network device receives the second message from an operation and maintenance OM device. Correspondingly, the operation and maintenance OM device sends the second message to the first access network device.

Embodiment 3: A dual connectivity protocol stack is compatible with an interface that is used for connecting a master node and a core network device and that is defined in a plurality of communication standards.

Currently, when an access network device is connected to a 4G core network device, the access network device and the 4G core network device are connected through an S1 interface defined in a 4G communication standard. When the access network device is connected to a 5G core network device, the access network device and the 5G core network device are connected through an Ng interface defined in a 5G communication standard. The access network device supports only an interface that is used for connecting the access network device to the core network device and that is defined in one communication standard. As introduced in Embodiment 2, when a core network device is upgraded, conversion from an X2 interface to an Xn interface needs to be supported. For connection between the access network device and the core network device, conversion from the S1 interface to the Ng interface also needs to be supported, and a problem of complex upgrade also exists.

A new dual connectivity protocol stack provided in this application includes an interface that is used for connecting the access network device and the core network device and that is defined in the plurality of communication standards, for example, the S1 interface defined in the 4G communication standard, the Ng interface defined in the 5G communication standard, an interface (for example, referred to as an N6 interface) that is used for connecting the access network device and the core network device and that is defined in a 6G communication standard, and two or more of interfaces (for example, referred to as an N7 interface) that are used for connecting the access network device and the core network device and that are defined in a 7G communication standard.

Optionally, a selective switch may also be set. Regardless of which communication standard is used by the core network device, the access network device needs only to select an interface corresponding to the communication standard to connect to the core network device, and does not need to upgrade the interface. For example, an Ng interface is used for connection to a 5G core network device, and an N6 interface is used for connection to a 6G core network device.

In an example, the first access network device supports a second interface defined in a first communication standard and a third interface defined in a second communication standard. When a first core network uses the first communication standard, the first access network device is connected to the first core network device using the first communication standard through the second interface; or when the first core network uses the second communication standard, the first access network device is connected to the first core network device using the second communication standard through the third interface.

In the conventional technology, the access network device supports only an interface that is used for connecting the access network device to the core network device and that is defined in one communication standard, for example, supports only the second interface or the third interface. When the first access network device changes from a core network device connected to the first communication standard to a core network device connected to the second communication standard, the access network device needs to upgrade the second interface to the third interface. Alternatively, when the first access network device changes from a core network device connected to the second communication standard to a core network device connected to the first communication standard, the access network device needs to upgrade the third interface to the second interface. The upgrade process is complex. However, in this possible implementation, the first access network device supports an interface that is used for connecting the access network device to the core network device and that is defined in a plurality of communication standards. After the communication standard used by the first core network device is updated, the first access network device may flexibly select an interface defined in a corresponding communication standard, to connect to the first core network device without upgrading the interface.

Embodiment 4: A new dual connectivity protocol stack is equivalent to deleting some of functions from the MR-DC protocol stacks in FIG. 2 and FIG. 3, to reduce system complexity.

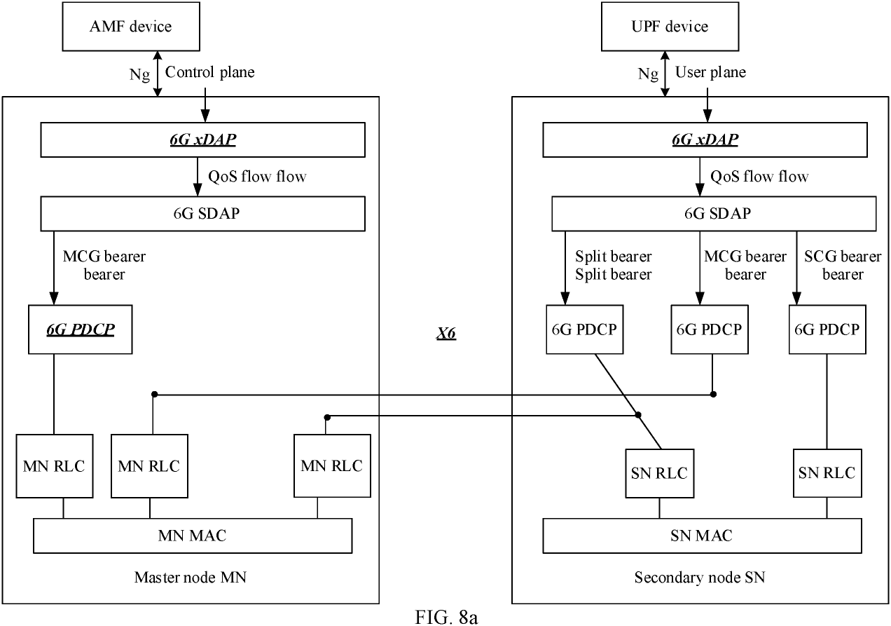

In a 6G dual connectivity architecture, to reduce system complexity, a function defined by MR-DC in NR may be appropriately deleted. There may be the following three examples (which are respectively Alt-1, Alt-2, and Alt-3) shown in FIG. 7:

As shown in FIG. 7, Alt-1 supports only an EN-DC-like solution, supports only an SN terminated SCG bearer and/or a split bearer, and does not support an MN terminated MCG bearer, an SCG bearer, or a split bearer.

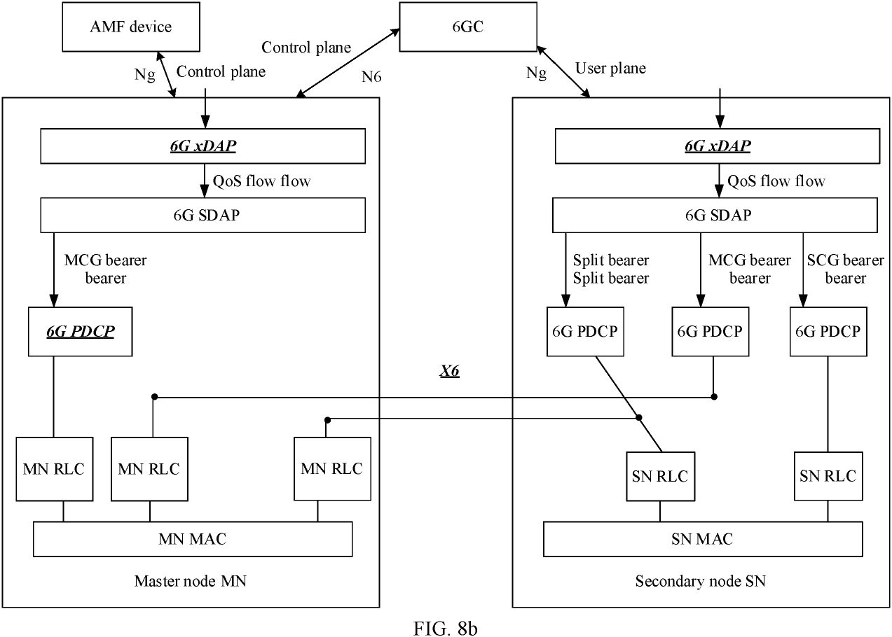

As shown in FIG. 8a, a master node (MN) supports only an Ng interface, and does not support N6. Only a secondary node SN is connected to a 6GC user plane (UP). In an EN-DC-like dual connectivity protocol stack, data splitting supports only an SN terminated bearer (for example, a split bearer).

As shown in FIG. 7, Alt-2 supports only EN-DC-like and NR-DC-like solutions (corresponding to N6-DC and 6G-DC in 6G DC), and supports only an SN terminated SCG bearer and/or a split bearer.

As shown in FIGS. 8b, a master node (MN) supports both an Ng interface and an N6 interface, but the handover is selective. Only a secondary node SN is connected to a 6GC user plane UP. In an MR-DC-like dual connectivity protocol stack, data splitting supports only an SN terminated split bearer.

As shown in FIG. 7, Alt-3 supports only EN-DC-like and NR-DC-like solutions (corresponding to N6-DC and 6G-DC in 6G DC), and supports an MN terminated MCG bearer, an SCG bearer, a split bearer, and an SN terminated bearer, for example, an SCG bearer and/or a split bearer.

As shown in FIGS. 8c, a master node (MN) supports both an Ng interface and an N6 interface, but the handover is selective. Both the MN and the SN are connected to a 6GC user plane UP. In an MR-DC-like dual connectivity protocol stack, data splitting supports both MN and SN terminated.

It should be noted that the protocol layers included in FIG. 8a, FIG. 8b, and FIG. 8c are merely examples. Alternatively, some of protocol layers may be deleted based on these protocol layers, for example, an xDAP layer and an SDAP layer are deleted.

The simplified DC architecture designed in this embodiment reduces protocol complexity and system complexity by deleting a function defined by MR-DC in NR, and can be flexibly applied to a plurality of networks, a plurality of types of base stations, and a plurality of carrier and spectrum types. This is a future development direction. For example, the architecture is applicable to a plurality of types of access point networks, for example, a terrestrial network, a non-terrestrial network, an uncrewed aerial vehicle network, an MAV network, or a satellite network.

It may be understood that, to implement the functions in the foregoing embodiments, the access network device, the terminal, and the core network device include corresponding hardware structures and/or software modules for performing the functions. A person skilled in the art should be easily aware that, in combination with the units and the method steps in the examples described in embodiments disclosed in this application, this application can be implemented by using hardware or a combination of hardware and computer software. Whether a function is performed by using hardware or hardware driven by computer software depends on a particular application scenario and design constraint of the technical solutions.

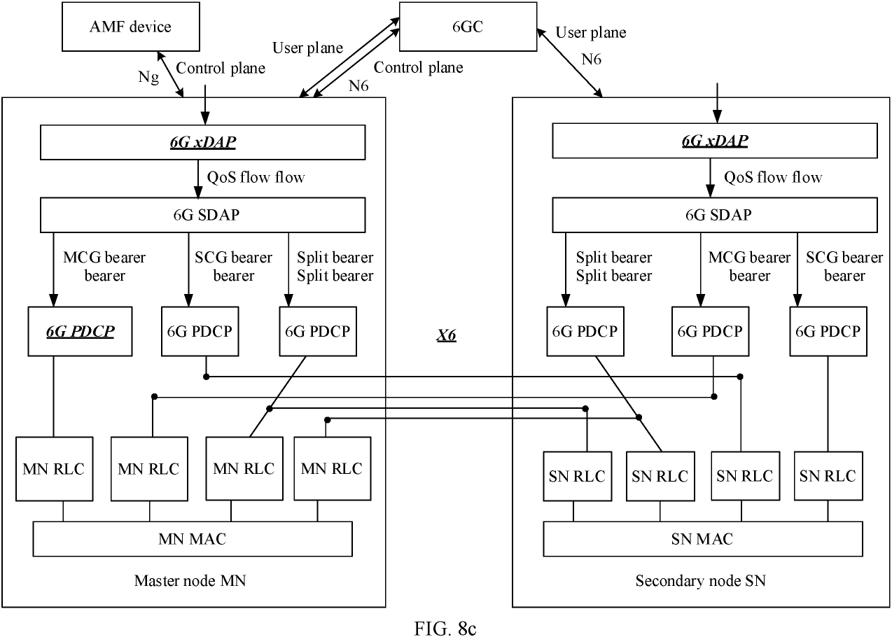

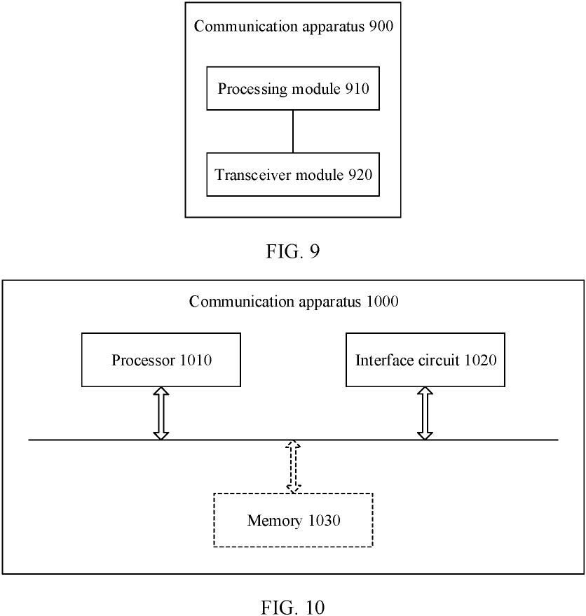

FIG. 9 and FIG. 10 are schematic diagrams of possible structures of communication apparatuses according to embodiments of this application. These communication apparatuses may be configured to implement functions of the access network device, the terminal, or the core network device in the foregoing method embodiments, and therefore can also achieve beneficial effects of the foregoing method embodiments.

As shown in FIG. 9, a communication apparatus 900 includes a processing module 910 and a transceiver module 920. The communication apparatus 900 is configured to implement functions of the access network device, the terminal, or the core network device in the foregoing method embodiments.

When the communication apparatus 900 is configured to implement functions of the terminal in the method embodiment shown in FIG. 6, the transceiver module 920 is configured to receive first configuration information, and the processing module 910 is configured to communicate with a first access network device based on the first configuration information.

When the communication apparatus 900 is configured to implement functions of the first access network device in the method embodiment shown in FIG. 6, the transceiver module 920 is configured to send the first configuration information, and the processing module 910 is configured to: determine the first configuration information, and communicate with a terminal based on the first configuration information.

For more detailed descriptions of the processing module 910 and the transceiver module 920, directly refer to related descriptions in the foregoing method embodiments. Details are not described herein again.

As shown in FIG. 10, a communication apparatus 1000 includes a processor 1010 and an interface circuit 1020. The processor 1010 and the interface circuit 1020 are coupled to each other. It may be understood that the interface circuit 1020 may be a transceiver or an input/output interface. Optionally, the communication apparatus 1000 may further include a memory 1030, configured to store instructions executed by the processor 1010, input data required for running instructions by the processor 1010, or data generated after the processor 1010 runs instructions.

When the communication apparatus 1000 is configured to implement the method shown in FIG. 6, the processor 1010 is configured to implement a function of the processing module 910, and the interface circuit 1020 is configured to implement a function of the transceiver module 920.

When the communication apparatus is a chip applied to a terminal device, the chip in the terminal device implements functions of the terminal device in the foregoing method embodiments. The chip in the terminal device receives information from another module (for example, a radio frequency module or an antenna) in the terminal device, where the information is sent by a network device to the terminal device. Alternatively, the chip in the terminal device sends information to another module (for example, a radio frequency module or an antenna) in the terminal device, where the information is sent by the terminal device to a network device.

When the communication apparatus is a chip used in an access network device, the chip in the access network device implements functions of the access network device in the foregoing method embodiments. The chip in the access network device receives information from another module (for example, a radio frequency module or an antenna) in the access network device, where the information is sent by a terminal device to the access network device. Alternatively, the chip in the access network device sends information to another module (for example, a radio frequency module or an antenna) in the access network device, where the information is sent by the access network device to a terminal device.

It may be understood that the processor in embodiments of this application may be a central processing unit (CPU), may be another general-purpose processor, a digital signal processor (DSP), an application-specific integrated circuit (ASIC), a field programmable gate array (FPGA), another programmable logic device, a transistor logic device, a hardware component, or any combination thereof. The general-purpose processor may be a microprocessor or any regular processor or the like.

The method steps in embodiments of this application may be implemented in a hardware manner, or may be implemented in a manner of executing software instructions by the processor. The software instructions may include a corresponding software module. The software module may be stored in a random-access memory, a flash memory, a read-only memory, a programmable read-only memory, an erasable programmable read-only memory, an electrically erasable programmable read-only memory, a register, a hard disk, a removable hard disk, a CD-ROM, or any other form of storage medium well-known in the art. For example, a storage medium is coupled to a processor, so that the processor can read information from the storage medium and write information into the storage medium. Certainly, the storage medium may be a component of the processor. The processor and the storage medium may be disposed in an ASIC. In addition, the ASIC may be located in a network device or a terminal device. Certainly, the processor and the storage medium may exist in the network device or the terminal device as discrete components.

All or some of the foregoing embodiments may be implemented by using software, hardware, firmware, or any combination thereof. When software is used to implement the embodiments, all or some of embodiments may be implemented in a form of a computer program product. The computer program product includes one or more computer programs and instructions. When the computer programs or instructions are loaded and executed on a computer, all or some of the procedures or functions in embodiments of this application are executed. The computer may be a general-purpose computer, a dedicated computer, a computer network, a network device, user equipment, or another programmable apparatus. The computer programs or instructions may be stored in a computer-readable storage medium, or may be transmitted from a computer-readable storage medium to another computer-readable storage medium. For example, the computer programs or instructions may be transmitted from a website, computer, server, or data center to another website, computer, server, or data center in a wired manner or in a wireless manner. The computer-readable storage medium may be any usable medium that can be accessed by a computer, or a data storage device, such as a server or a data center, integrating one or more usable media. The usable medium may be a magnetic medium, for example, a floppy disk, a hard disk, or a magnetic tape; or may be an optical medium, for example, a digital video disc; or may be a semiconductor medium, for example, a solid-state disk.

In the embodiments of this application, unless otherwise stated or there is a logical conflict, terms and/or descriptions between different embodiments are consistent and may be mutually referenced, and technical features in different embodiments may be combined based on an internal logical relationship thereof, to form a new embodiment.

In this application, “at least one” means one or more, and “a plurality of” means two or more. “And/or” describes an association relationship between associated objects, and represents that three relationships may exist. For example, A and/or B may represent the following cases: Only A exists, both A and B exist, and only B exists, where A and B may be singular or plural. In the text descriptions of this application, the character “/” generally indicates an “or” relationship between the associated objects. In a formula in this application, the character “/” indicates a “division” relationship between the associated objects.

It may be understood that various numbers in embodiments of this application are merely used for differentiation for ease of description, and are not used to limit the scope of embodiments of this application. The sequence numbers of the foregoing processes do not mean an execution sequence, and the execution sequence of the processes should be determined based on functions and internal logic of the processes.

What is claimed is:

1. A method, comprising:
determining, by a first access network device, first configuration information, wherein the first access network device is connected to a first core network device, the first core network device uses a first communication standard or a second communication standard, the first configuration information comprises status indication information of a first protocol layer of the second communication standard, the status indication information indicates a first state or a second state of the first protocol layer, the first state indicates a terminal to perform a function of the first protocol layer, the second state indicates the terminal not to perform a function of the first protocol layer, and the first protocol layer comprises a service data adaptation protocol (SDAP) layer; and
sending, by the first access network device, the first configuration information to the terminal.

2. The method according to claim 1, further comprising:
sending, by the first access network device, a first message to a second access network device, wherein the first message comprises information that indicates a communication standard used by the first core network device.

3. The method according to claim 2, wherein sending, by the first access network device, the first message to the second access network device comprises:
sending, by the first access network device, the first message to the second access network device through a first interface that uses the second communication standard.

4. The method according to claim 3, wherein:
the first access network device supports a second interface and a third interface; and
the first access network device is connected to the first core network device using the first communication standard through the second interface, wherein the second interface is defined in the first communication standard; or
the first access network device is connected to the first core network device using the second communication standard through the third interface, wherein the third interface is defined in the second communication standard.

5. The method according to claim 2, further comprising:
receiving, by the first access network device, a second message, wherein the second message comprises information that indicates a communication standard used by the first core network device.

6. The method according to claim 5, wherein receiving, by the first access network device, the second message comprises:
receiving, by the first access network device, the second message from the first core network device; or
receiving, by the first access network device, the second message from an operation and maintenance (OM) device.

7. A method, comprising:
receiving, by a terminal, first configuration information from a first access network device, wherein the first access network device is connected to a first core network device, the first core network device uses a first communication standard or a second communication standard, the first configuration information comprises status indication information of a first protocol layer of the second communication standard, the status indication information indicates a first state or a second state of the first protocol layer, the first state indicates the terminal to perform a function of the first protocol layer, the second state indicates the terminal not to perform a function of the first protocol layer, and the first protocol layer comprises a service data adaptation protocol (SDAP) layer; and
communicating, by the terminal, with the first access network device based on the first configuration information.

8. An apparatus, comprising:
at least one processor; and
one or more memories coupled to the at least one processor and storing programming instructions for execution by the at least one processor to perform operations comprising:
determining first configuration information, wherein the apparatus is connected to a first core network device, the first core network device uses a first communication standard or a second communication standard, the first configuration information comprises status indication information of a first protocol layer of the second communication standard, the status indication information indicates a first state or a second state of the first protocol layer, the first state indicates a terminal to perform a function of the first protocol layer, the second state indicates the terminal not to perform a function of the first protocol layer, and the first protocol layer comprises a service data adaptation protocol (SDAP) layer; and
sending the first configuration information to the terminal.

9. The apparatus according to claim 8, the operations further comprising:
sending a first message to a second access network device, wherein the first message comprises information that indicates a communication standard used by the first core network device.

10. The apparatus according to claim 9, wherein sending the first message to the second access network device comprises:
sending the first message to the second access network device through a first interface that uses the second communication standard.

11. The apparatus according to claim 10, wherein:
the apparatus supports a second interface and a third interface; and
the apparatus is connected to the first core network device using the first communication standard through the second interface, wherein the second interface is defined in the first communication standard; or
the apparatus is connected to the first core network device using the second communication standard through the third interface, wherein the third interface is defined in the second communication standard.

12. The apparatus according to claim 9, the operations further comprising:
receiving a second message, wherein the second message comprises information that indicates a communication standard used by the first core network device.

13. The apparatus according to claim 12, wherein receiving the second message comprises:
receiving the second message from the first core network device; or
receiving the second message from an operation and maintenance (OM) device.
